(19) United States
(12) Patent Application Publication
(10) Pub. No.: US 2022/0297854 A1
(43) Pub. Date: Sep. 22, 2022

(54) METHOD FOR OPTIMIZING THE ENERGY MANAGEMENT OF AN AERONAUTICAL ASSEMBLY TO REDUCE GREENHOUSE GAS EMISSIONS AND ASSOCIATED DIGITAL PLATFORM

(71) Applicant: REVIMA GROUP, RIVES-EN-SEINE (FR)

(72) Inventors: MARIE-LAURE BOURGUEIL, RIVES-EN-SEINE (FR); JEAN-PHILIPPE BEAUJARD, RIVES-EN-SEINE (FR); OLIVIER HODAC, RIVES-EN-SEINE (FR); MAGDALENA TRZECIAKOWSKA, RIVES-EN-SEINE (FR); CHRISTOPHE MICHEL, RIVES-EN-SEINE (FR); XAVIER MORNAND, RIVES-EN-SEINE (FR); OLIVIER HY, RIVES-EN-SEINE (FR)

(21) Appl. No.: 17/696,852

(22) Filed: Mar. 16, 2022

(30) Foreign Application Priority Data
Mar. 19, 2021 (EP) 21163751.7

(51) Int. Cl. B64F 5/60; B64F 5/40; B64F 1/36; G07C 5/08; G07C 5/00; B64D 41/00

(52) U.S. Cl. CPC B64F 5/60; B64F 5/40; B64F 1/36; G07C 5/0816; G07C 5/008; B64D 41/00

(57) ABSTRACT

A method for optimizing the energy management and reducing the greenhouse gas emissions of a complex aeronautical assembly comprising at least one aircraft and an auxiliary power unit (APU). The method analyzing, in a centralized manner outside the aeronautical assembly, data from the aeronautical assembly to compare at least one state of a parameter of the assembly with a predetermined optimal state of the parameter. The data measured by sensors of the aeronautical assembly are collected. The collected data is transmitted to a digital processing and analysis platform. The data is processed by the platform implementing machine learning algorithms. Information relating to the processed data is displayed on a dashboard accessible via different terminals. A real-time alert is generated in the case of detection of an anomaly in the aeronautical assembly.

### TECHNICAL FIELD

The present invention belongs to the field of aeronautics, in particular the energy management of an aeronautical assembly comprising at least one aircraft and equipment such as auxiliary power units, and relates more particularly to a method for optimizing the energy management of such an assembly for a reduction of its greenhouse gas emissions (hereinafter “GHG”) and its energy consumption, as well as a digital platform allowing the implementation of such a method.

### BACKGROUND OF THE INVENTION

In an increasingly competitive economic environment, companies must conduct their activities in an ever more efficient and cost-effective manner, especially in highly globalized industries such as aeronautics and commercial and military aviation. Consequently, the inefficiencies which were once tolerated by companies, due to the partitioned nature of customers and suppliers, must now be removed or attenuated so that companies can be effectively competitive in a highly dynamic global marketplace. Furthermore, the growing interest in eco-responsible operations which respect the environment is an additional motivation to minimize the polluting emissions, the unnecessary losses and ensure a reliable and safe method.

In in-service aircraft, such as airliners, many on-board pieces of equipment are subject to continuous supervision and regular maintenance in order to limit the security risk related to a possible malfunction of this equipment.

For example, the auxiliary power units APU are intended to generate energy on board airplanes to allow the ground (stopped engines) to power the different on-board systems by providing electrical and/or pneumatic generations. APUs can also be used in flight. In order to reduce the airplane fuel consumption, GHG emissions or in the case of APU failure, it is necessary to have on the ground, ground power units (power supply, hydraulic pressure) such as GPUs and a starting unit (pneumatic pressure).

In general, the management of the power supply operations of an airplane on the ground requires the intervention of several actors among the MRO companies, the airport operators and the technical ground crew of the airline operating the aircraft.

The multiplication of actors causes a complexity in the intervention and a lack of operational efficiency. Indeed, the involved actors work for the same objective, are often close to each other, but do not effectively share useful information. This results in a waste of time, unnecessary increase in the costs, and GHG emissions which could have been avoided.

In addition, a non-optimized use of the APU/GPU resources is necessarily accompanied by an energy waste, an increase in the operating costs for airlines and unnecessary GHG emissions.

An effective energy management of this equipment, in particular APUs, therefore proves to be necessary in order, on the one hand, to preserve said equipment and avoid premature failures, and on the other hand, to reduce their energy consumption and their polluting emissions.

The document U.S. Ser. No. 10/752,376B2 describes a pre-flight preparation system for an aircraft, comprising one or more power supply modules. An integrated controller is electrically and communicatively coupled to the power modules to supervise and control said modules in order to provide electrical energy to the aircraft subsystems. A mobile device such as a smartphone can be connected to the integrated controller to provide it with preparation instructions prior to the flight of the aircraft and to supervise the state of this preparation prior to the flight. In addition, this document describes a method for preconditioning an aircraft comprising determining a state of charge of an APU and activating an environmental monitoring subsystem to precondition the aircraft by adjusting a current temperature according to a pre-conditioning profile based on one or several parameters from: a target temperature, a target time, a current temperature, an outside air temperature, an amount of energy and a state of charge of the APU.

This solution only uses data specific to a single aircraft and does not allow any global knowledge of the environment in which the aircraft is operating, such as the airport or the state of other aircraft belonging to the same airline, for example.

The document FR3019358B1 describes a method and a device for the optimized global management of an energy network of an aircraft comprising a plurality of energy equipment, characterized in that it comprises a module for selecting at least one optimization objective among a plurality of predetermined objectives, a module for receiving equipment data, a module for receiving aircraft data, and a module for determining operating setpoints of the energy equipment based on equipment data and aircraft data adapted to achieve at least one selected optimization objective.

This solution does not allow anticipating anomalies from the available data, is limited to a single aircraft, similar to the previous solution, and does not offer any intuitive and simplified visualization of the data knowing that one of the major problems in MRO is the complexity of the information provided to the operators, said operators being sometimes induced in error. This solution also does not allow making recommendations for reducing energy consumption and GHG emissions.

### OBJECT AND SUMMARY OF THE INVENTION

The present invention aims at overcoming the drawbacks of the prior art set out above and proposes a global solution for optimizing the energy management and reducing the greenhouse gas emissions of a complex aeronautical assembly comprising at least one aircraft and equipment external to said aircraft, in particular during ground operations, in order to support airlines in their ground operations (mastering and reduction of the costs and polluting emissions), by offering them a centralized digital platform allowing operating in real time, via machine learning models, among other things, the data from aircraft and their connected equipment in order to optimize their operations.

The present invention also aims at providing technical and/or operational recommendations for reducing the energy consumption of aircraft and their equipment thanks to this optimized management, and therefore at improving the ecological footprint of the operation of an aircraft and external equipment.

To this end, the subject of the present invention is a method, implemented by processor-based computer, for optimizing the energy management and reducing the emissions, in particular the greenhouse gas emissions, of an aeronautical assembly comprising at least one aircraft and an auxiliary power unit called APU, said method analyzing, in a centralized manner outside the aeronautical assembly, data from said assembly in order to compare at least one state of a parameter of said assembly with a predetermined optimal state of said parameter.

This method is remarkable in that it comprises:
a data collection step, said data comprising data measured by sensors of the aeronautical assembly;
a step of transmitting the collected data to a digital processing and analysis platform, external to the aeronautical assembly;
a step of processing data by the platform, implementing machine learning algorithms, to predict a non-optimal state of a parameter, such as an energy overconsumption or a sub-optimal bias from an environmental point of view of the different power supply options of the aircraft, in the aeronautical assembly and/or to recommend actions in order to bring the state of said parameter as close as possible to the optimal state;
a step of displaying information relating to the processed data on a dashboard accessible via different terminals; and
a real-time alert step in the case of detection of an anomaly in the aeronautical assembly.

Advantageously, the data collection step is carried out in real time and continuously to limit the risks associated with late interventions and to track the accurate evolution of the measured operational parameters.

According to a particularly advantageous embodiment, the measured data comprises data from the APU of each aircraft of the aeronautical assembly. This allows carrying out an improved tracking of the APUs which are critical equipment.

According to one embodiment, the aeronautical assembly comprises, at least for a determined period, at least one external equipment such as a ground power unit GPU provided with at least one sensor measuring an operational parameter, said equipment being capable of communicating with the digital platform in particular to transmit the data measured by said sensor.

This allows, for example, an airline to know the state of the GPUs available on a given aerodrome and to be able to use them on the ground as a replacement for an APU when keeping said APU running is not recommended by the platform.

Advantageously, the data processing step allows in particular calculating an energy, power and/or fossil consumption, of one or more elements of the aeronautical assembly, and estimating an emission of polluting particles such as carbon dioxide (CO₂) and nitrogen oxides (NOₓ) by the aircraft of an airline.

According to one embodiment, the machine learning algorithms executed during the data processing step comprise predictive models configured to predict anomalies in an element of the aeronautical assembly such as energy overconsumption or failures. These predictive models can for example be driven on historical data and calibrated on the types of aircraft, equipment, etc.

According to the invention, the detection of an anomaly in an element of the aeronautical assembly is based on a comparison of at least one measured value for an operational parameter of the element with at least one reference value corresponding to a predetermined optimal operation.

The parameters in question comprise, but are not limited to, the duration of the transit, the outside temperature, the conditions of use of the APU in one or more airports, the number of available GPUs, etc.

In a particularly advantageous manner, the alert step is accompanied by a multi-channel notification to different users, on different interfaces (web portal, mobile application, etc.).

According to an advantageous embodiment, the recommendation step proposes different actions to the users of the platform depending on the competence and the authorization of each user. For example, in the case of simultaneous use of the APU and the GPU, the platform immediately recommends to the airline the stop of the APU to avoid unnecessary use of the APU and overconsumption of fuel resulting in polluting emissions in the airport.

The invention also relates to a digital platform comprising processing unit, calculation unit and storage device, capable of communicating on a wireless network, and configured to implement a method for optimizing the energy management and reducing the greenhouse gas emissions of an aeronautical assembly, as presented.

The fundamental concepts of the invention having just been exposed above in their most elementary form, other details and features will emerge more clearly on reading the following description and with regard to the appended drawings, giving by way of non-limiting example, an embodiment of a method for optimizing the energy management and reducing the greenhouse gas emissions of an aeronautical assembly and an associated digital platform, in accordance with the principles of the invention.

### BRIEF DESCRIPTION OF THE FIGURES

The figures are given for purely illustrative purposes for the understanding of the invention and do not limit the scope thereof. The different elements are represented schematically and are not necessarily to the same scale. In all figures, identical or equivalent elements have the same reference numeral.

It is thus illustrated in:

FIG. 1: a top view of an aircraft parked on the ground and on which external equipment intervenes;

FIG. 2: a side view of an aircraft with an apparent APU and electrically connected GPU;

FIG. 3: a set of aircraft from the same airline in service on a network of airports served by the airline;

FIG. 4: a global computer architecture for the implementation of a method according to the invention;

FIG. 5: the main steps of a method according to one embodiment of the invention;

FIG. 6: a schematic example of implementation of the method;

FIG. 7: an example of a web dashboard for viewing the information provided by the method implementation platform;

FIG. 8: an example of an alert and notification sequence in the case of an anomaly; and

FIG. 9: an example of a heading being displayed on a mobile application associated with the digital platform.

### DETAILED DESCRIPTION OF EMBODIMENTS

It should be noted that certain technical elements well known to those skilled in the art are described herein to avoid any insufficiency or ambiguity in the understanding of the present invention.

In the embodiment described below, reference is made to a method for optimizing the energy management and reducing the GHG emissions of an aeronautical assembly, intended mainly for the real-time monitoring of an auxiliary power unit and the like. This non-limiting example is given for a better understanding of the invention and does not exclude the implementation of the method for the real-time monitoring of any other aeronautical equipment whether it is on board the aircraft or on the ground.

In the remainder of the description, the acronyms APU, GPU, ACU and MRO respectively designate an auxiliary power unit, a ground power unit, an air conditioning unit and the maintenance, repair and overhaul. The expression “connected object” refers to an object equipped with means capable of communicating, autonomously, with other objects connected to an Internet-type network.

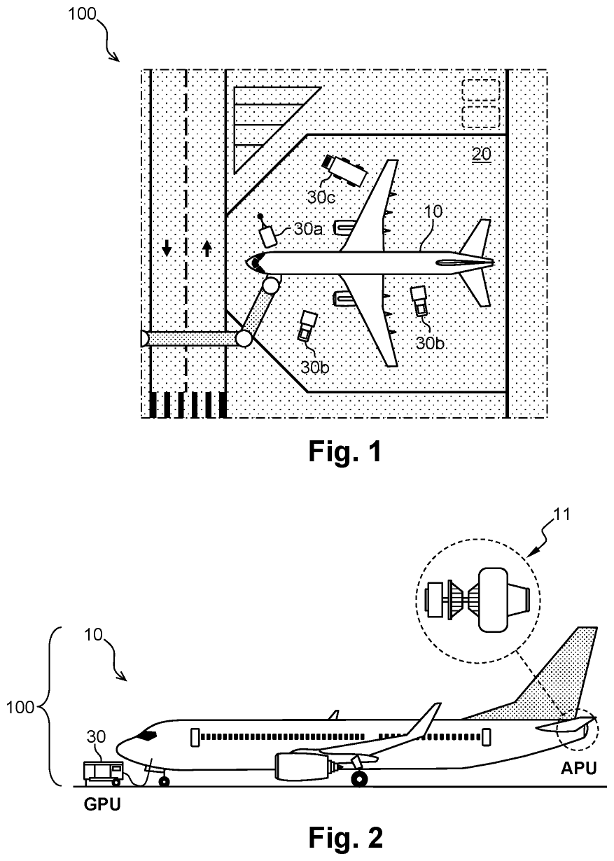

FIG. 1 represents an aircraft 10, of the airliner type, on a parking area (tarmac) of an aerodrome, the aircraft having left the runway after a landing and being prepared to join it again for a take-off. In the meantime, operations are carried out on the aircraft 10, in particular the boarding and/or the disembarkation of travelers, the loading and/or the unloading of freight, the fueling and maintenance.

Concerning the fueling and maintenance operations, appropriate equipment, in the form of vehicles, is rushed in the vicinity of the aircraft 10 in order to perform specific interventions which are previously programmed or, if necessary, decided following contingencies. The necessary interventions can be performed simultaneously by different actors (airport operators, MRO, technical ground crew of the airline operating the aircraft, etc.).

The equipment in question comprises, for example, power groups 30a such as GPUs, utility or support groups (air conditioning, water, etc.) 30b such as ACUs, refueling operators 30c, as well as any other equipment necessary for the aircraft ground handling. This equipment will be generically designated by the reference numeral 30.

In view of their multiple interactions, the aircraft 10 and the equipment 30 evolve in a complex system and can be grouped within an aeronautical assembly 100 allowing the implementation of a method according to the invention to optimize the energy management of each element of said assembly.

The aeronautical assembly 100 can be defined in different manners depending on the industrial objectives targeted by the method of the invention.

The aeronautical assembly 100 can either be fixed and always comprise the same elements (same aircraft and same equipment), or variable and changes elements according to specific rules. In the latter case, the aeronautical assembly 100 can for example be defined with reference either to a given zone, delimited on a given aerodrome, and therefore comprise all elements contained in said zone, either to a given airline, or to an airline alliance, and include all active aircraft in the fleet, either at a given airport or at a given airport network. The aeronautical assembly 100 can also be defined by combining fixed elements and variable elements.

In all cases, the aeronautical assembly 100 must comprise at least one aircraft 10. Therefore, the aeronautical assembly 100 necessarily comprises on-board systems of the aircraft 10 such as the APU, which will be referred to as “internal equipment” as opposed to the aforementioned “external equipment” (GPU, ACU, etc.).

FIG. 2 represents an example of an aeronautical assembly 100 comprising an aircraft 10, an APU 11 of the aircraft, as internal equipment, and a GPU 30 as external equipment. The GPU is herein electrically connected to the aircraft 10.

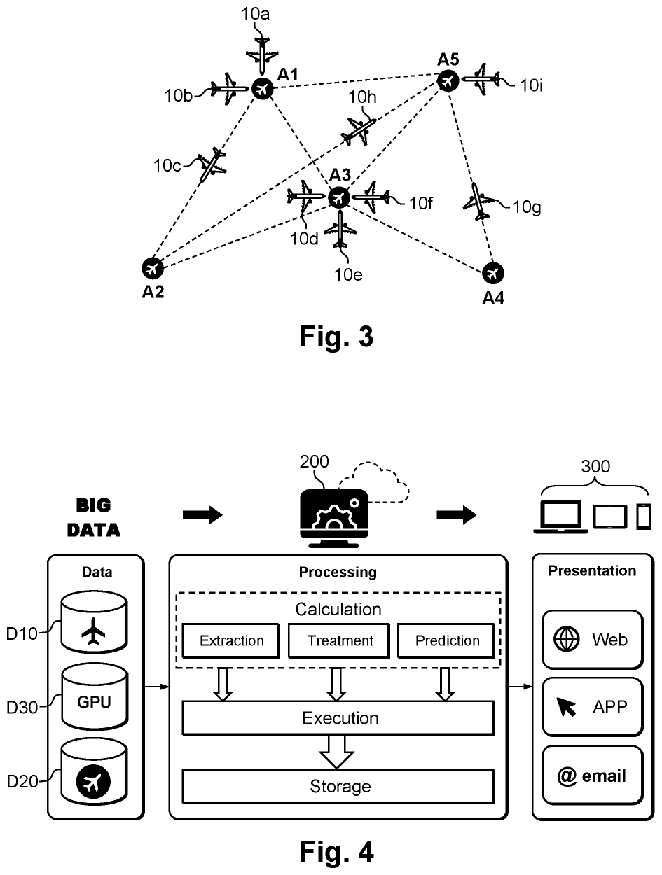

FIG. 3 represents a plurality of aircraft 10a to 10i operated by an airline on a network of airports A1 to A5 served by said airline. Among the represented aircraft, some are in flight (10c, 10g and 10h) and others on the ground, parked in certain airports (A1, A3 and A5).

The aircraft and the airports of the simplified example of FIG. 3 can be grouped in an aeronautical assembly for the implementation of the method of the invention. The complexity of such an assembly and the amount of data it is capable of generating increases with the number of elements (aircraft and airports).

Nevertheless, the implementation of the method of the invention on such an assembly is only a multiplication of its implementation on each of the constituent elements of the assembly taken independently. Consequently, the description of the method can be made from a simplified aeronautical assembly such as that of FIGS. 1 and 2, while remaining valid for a more complex aeronautical assembly, within the limits of the conditions defined above.

The method for optimizing the energy management of an aeronautical assembly mainly allows exploiting data collected from different sources (aircraft, internal/external equipment, airports, and possibly airlines) to provide users with an effective decision support tool allowing them to considerably improve their interventions, especially from a logistical point of view, and limiting as much as possible any unnecessary energy consumption in the aeronautical assembly.

FIG. 4 represents a global computer architecture allowing exploiting the data according to the method of the invention, the latter being organized into three paradigms: the collection of the data, the processing of the data and the presentation of information in order to elicit the action of a user.

The data collection is done by means of sensors installed on the elements of the aeronautical assembly. For example, the internal equipment of an aircraft has sensors which measure various physical, technical or other parameters.

The parameters measured by the sensors of the aeronautical assembly are sent, in real time or at regular time intervals, to an off-board analysis platform 200, by means of a wireless network. At the request of the calculation means of said platform, parameters are transmitted thereto by adapted servers. These means then perform a series of calculations by executing dedicated programs. Among the programs installed on the platform 200, some carry out a simple presentation, interactive or not, of the data collected, others carry out a multifaceted interpretation and representation of the data, and still others compile artificial intelligence algorithms to predict information not available as is, in order to provide the necessary recommendations to optimize the energy consumption and the emissions of the aeronautical assembly.

Thus, an “intelligent” control of the aeronautical assembly 100, in particular in terms of energy management, can be carried out according to the method of the invention.

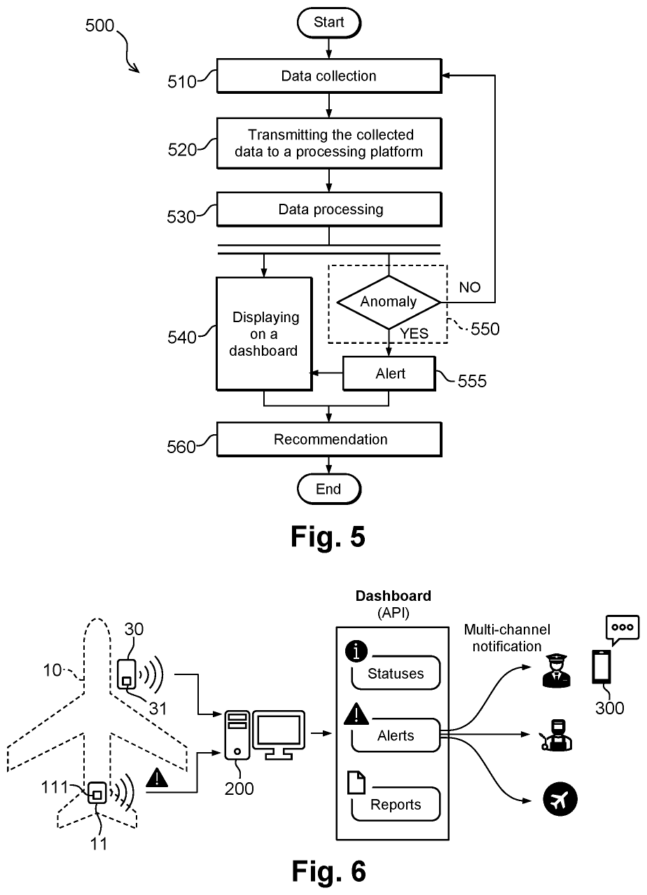

FIG. 5 represents the main steps of a method for optimizing the energy management of an aeronautical assembly, this method comprising:
an initial step 510 of data collection;
a step 520 of transmitting the collected data to a processing platform;
a data processing step 530;
a step 540 of displaying the processed data via a dedicated interface;
a conditional anomaly detection step 550;
a real-time alert step 555 in the case of an anomaly;
a step 560 of recommending one or more appropriate actions.

FIG. 6 illustrates an example implementation of the steps of the above method in the case of an aeronautical assembly comprising an aircraft 10 and at least one external equipment 30 such as a GPU, said aircraft comprising at least one internal equipment 11 such as an APU.

The internal equipment 11 and the external equipment 30 each comprise one or more sensors 111 and 31 measuring the operating parameters of the equipment.

The sensors of the equipment perform measurements in real time and continuously, and transmit the collected data to the digital processing platform 200 via any adapted network such as a network compatible with the Internet of Things (IoT). To this end, the equipment of the aeronautical assembly is capable to communicate on such a network, or includes, integrated, “intelligent” electronic boxes which allows both collecting the measured data and transmitting them.

After processing them by the calculation means of the platform 200, the data is displayed on a dashboard in a usable form, preferably intuitive and simplified, by using data mining techniques for example. This dashboard can be designed as an application programming interface API and accessible from several terminals 300 such as personal communication devices (smartphones, digital tablets, computers, etc.) represented in FIG. 4.

The dashboard allows compiling the essential information for decision support concerning the energy management operations of the aeronautical assembly. This information is, among other things, presented in the form of equipment statuses, alerts, automatically generated reports, etc. For example, the dashboard comprises the history of the emissions and savings made, allows making future projections on different parameters, allows the user to record the root causes of uses detected as sub-optimal to target the malfunctions to be resolved by the Pareto principle or a similar principle.

Due to their criticality, the alerts are for example notified in real time to several actors simultaneously (pilots, MRO operators, airports). This multi-channel notification of alerts allows mastering the risks relating to the anomalies having triggered said alerts and ensuring a certain redundancy in the verification, especially since double verification is often required with the air authorities.

With reference to FIG. 5, the initial step 510 of collecting data consists in bringing together a large amount of data (big data) from different available sources.

Firstly, the data originates from the considered aeronautical assembly and comprises the parameters measured in real time and continuously by the sensors of the different “connected” equipment (APU, GPU, ACU, etc.), the data specific to air traffic, the data from the airports, the data from the airlines, as well as any other contextual data (weather, energy tariffs, etc.) necessary for the execution of specific calculation models during the processing step 530.

The main data sources are represented in FIG. 4 and combine aircraft data D10 (the latter naturally comprising internal equipment data), external equipment data D30 and airport data D20.

Of course, some data can be collected in deferred time, at regular time intervals or at the request of the user.

The collected data is then transmitted to the digital processing platform, said platform includes physical or cloud servers accessible on a suitable communication network.

The data transmission step 520 is preferably carried out in real time for optimal tracking of the changes in the different parameters of the aeronautical assembly. This transmission is necessarily carried out on secure channel or channels and may make use signal encoding or encryption techniques, or even blockchain security also allowing timestamping the data transmitted before the processing thereof.

The data processing step 530 consists in executing a series of calculations and analyses in order to make the collected data usable and allow the user to take the necessary actions to optimize the energy management of the aeronautical assembly.

This processing step is implemented by calculation unit, of the computer type, of the digital platform, implementing, among others, artificial intelligence algorithms to carry out predictive analyses.

More specifically, machine learning models allows predicting the occurrence of anomalies such as energy overconsumption or failures in the aeronautical assembly, but also recommending actions based on historical data and interventions available for said assembly or from another aeronautical assembly.

The data processing step 530 also allows executing calculations based on standard models of energy consumption, emission of polluting particles (CO₂, NOₓ), and the like, for example to estimate operating costs (fuel, taxes, etc.) and recommend actions to reduce said costs.

The different operated calculations can use geolocation data from the elements of the aeronautical assembly in order to refine the desired optimization.

For example, when the intervention of a GPU is necessary on an aircraft, knowing the exact coordinates of said parked aircraft and the different available GPUs allows choosing the closest GPU or the one fulfilling specific criteria according to a given collaborative model.

The activity data of an element of the aeronautical assembly can be, in turn, extracted from the measurements of the movement of said element (displacement on the tarmac for example) or, when the latter is stationary, from the measurements of a vibration sensor installed in the element and set to a vibration threshold corresponding to an effective activity.

The vibration measurements of an element, an APU for example, can also be used to predict anomalies or failures by analyzing the recorded vibration profiles.

During the data processing step, different algorithms can be used, among which predictive algorithms such as ordinary least squares, regularization methods, Lasso method, a logistic regression, a random forest, a gradient boosting, a support vector machine, a stochastic gradient algorithm, k-K-nearest neighbor method; and data classification and partitioning algorithms such as K-means, Gaussian mixture model, a spectral partitioning, the DBSCAN algorithm, interactive partitioning, isolation forest for anomaly detection, etc.

The results of the different processing operations are then displayed on the dashboard during the display step 540.

The dashboard is accessible from different terminals and allows different users to access information in real time.

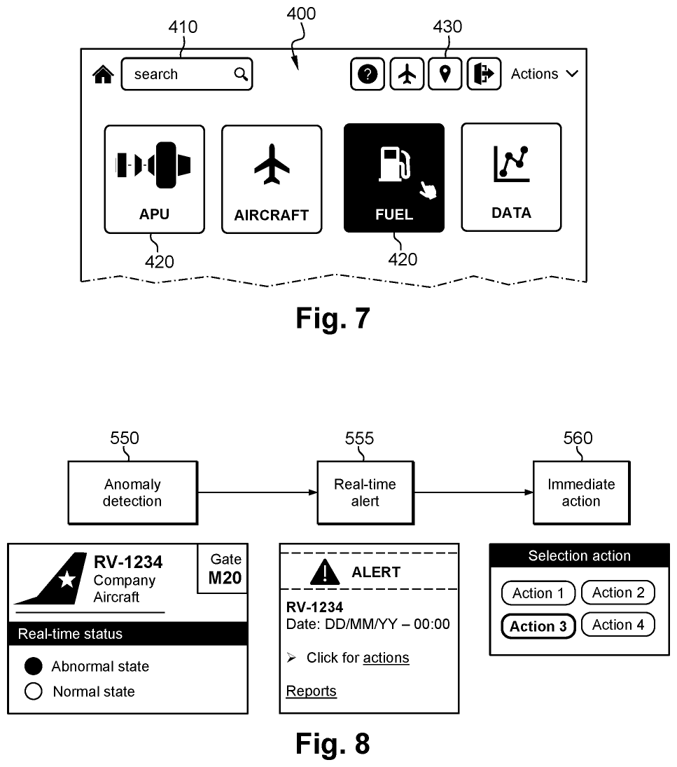

FIG. 7 represents an example of a home page of a dashboard 400 accessible from a web page (secure access to a user space).

The dashboard 400 is a graphical interface adapted to each user and includes components to facilitate the navigability, the access to information and the tracking.

Generally, this dashboard includes the main headings of the energy management, indicated by tabs 420 with pictograms for example, herein APU, aircraft, fuel and data.

The dashboard 400 can further have a search bar 410 for a quick access to specific data, additional customizable buttons 430, as well as any other component or interface tool simplifying the use of the dashboard.

Thus, the dashboard allows accessing the different performed data processing, but above all monitoring in real time the cases of alerts and offering the user immediate communication means to manage these alerts.

FIG. 8 gives an example of display windows accompanying the management of an alert, from the detection step 550 to the action step 560. The alert can also be notified on different channels for the same user, for example both on a mobile application and by a message on a mobile telephone network (SMS) to overcome the absences or interruptions of internet connection, a connection necessary for the operation of the mobile application.

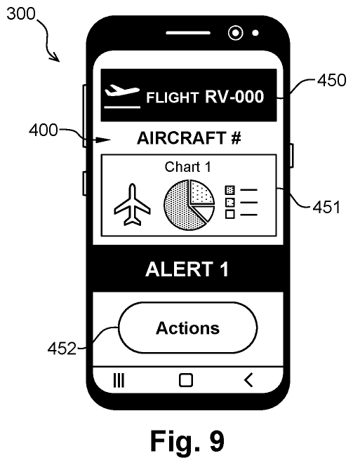

FIG. 9 finally gives an example of a dashboard 400 for a mobile application, displayed on a smartphone 300. In this case of reduced display, the dashboard preferably displays a single heading per window for a better readability. Herein a pre-flight section 450 is displayed with the references of the flight and the aircraft. An information box 451 can be provided to show relevant data directly linked, for example, to a sent alert. An active menu 452 for choosing actions can also be displayed on the screen in the case of an alert.

The person skilled in the art easily understands that the dashboard can be adapted according to the need of each user.

It clearly emerges from the present description that some steps of the method can be changed, replaced or deleted and that some adjustments can be made to the implementation of this method according to the targeted objectives, without thereby departing from the scope of the invention.

1-10. (canceled)

11. A computer-implemented method for optimizing an energy management and reducing greenhouse gas emissions of an aeronautical assembly comprising at least one aircraft and an auxiliary power unit, the method comprising:
collecting data from the aeronautical assembly, the data comprising data measured by sensors of the aeronautical assembly;
transmitting the data collected for analysis, in a centralized manner outside the aeronautical assembly, to a digital processing and analysis platform, external to the aeronautical assembly;
processing data by the digital processing and analysis platform, implementing machine learning algorithms, to compare at least one state of a parameter of the aeronautical assembly with a predetermined optimal state of the parameter and at least one of the following: to predict a non-optimal state of the parameter and to recommend actions in order to bring the state of the parameter as close as possible to the predetermined optimal state;
displaying information relating to the data processed on a dashboard accessible via different terminals; and
generating a real-time alert in response to a detection of an anomaly in the aeronautical assembly.

12. The method of claim 11, wherein the collection of the data is carried out in real time and continuously.

13. The method of claim 11, wherein the data measured comprises data from the auxiliary power unit of each aircraft of the aeronautical assembly.

14. The method of claim 11, wherein the aeronautical assembly comprises, at least for a predetermined duration, at least one external equipment being configured to communicate with the digital processing and analysis.

15. The method of claim 14, wherein said at least one external equipment is a ground power unit provided with at least one sensor measuring an operational parameter.

16. The method of claim 15, wherein said at least one external equipment is configured to transmit the data measured by said at least one sensor.

17. The method of claim 11, wherein the digital processing and analysis platform is configured to calculate at least one of energy, power and fossil consumption, of one or more elements of the aeronautical assembly and estimating an emission of polluting particles by the aircraft.

18. The method of claim 17, wherein the polluting particles are carbon dioxide (CO₂) and nitrogen oxides (NOₓ) emitted by the aircraft

19. The method of claim 11, wherein the machine learning algorithms comprise predictive models configured to predict anomalies in an element of the aeronautical assembly.

20. The method of claim 19, wherein the anomalies are energy overconsumption or failures.

21. The method of claim 11, wherein the detection of the anomaly in the element of the aeronautical assembly is based on a comparison of at least one measured value for an operational parameter of the element with at least one reference value corresponding to a predetermined optimal operation.

22. The method of claim 11, wherein the generation of the real-time alert is accompanied by a multi-channel notification to different users.

23. The method of claim 11, wherein different recommend actions are proposed by the digital processing and analysis platform depending on a competence and an authorization of each user.

24. A digital platform comprising processing unit and computer storage device, and the digital platform configured to communicate on a wireless network and to implement the method for optimizing the energy management and reducing the greenhouse gas emissions of an aeronautical assembly of claim 11.
